(19) United States
(12) Patent Application Publication
(10) Pub. No.: US 2020/0225701 A1
(43) Pub. Date: Jul. 16, 2020

(54) DOCKING STATION

(71) Applicant: PEGATRON CORPORATION, Taipei City (TW)

(72) Inventors: Wei-Chun Tsao, Taipei City (TW); Chung-En Wu, Taipei City (TW); Wei-Hsin Chen, Taipei City (TW)

(73) Assignee: PEGATRON CORPORATION, Taipei City (TW)

(21) Appl. No.: 16/693,014

(22) Filed: Nov. 22, 2019

(30) Foreign Application Priority Data
Jan. 10, 2019 (TW) 108200477

(51) Int. Cl. G06F 1/16; F21V 33/00; G06F 1/20; H01Q 5/307

(52) U.S. Cl. CPC G06F 1/1632; F21V 33/0052; F21Y 2115/10; H01Q 5/307; G06F 1/203

(57) ABSTRACT

A docking station is provided, including a base, a pair of support frames, two pairs of antennas, a pair of first connecting ports, and a communication chip. The support frames, the first connecting ports, and the communication chip are all disposed on the base. The support frames can rotate relative to the base, the antennas are disposed in the support frames to receive a wireless signal, and the pair of first connecting ports is individually movably disposed on both opposite sides of the base and far away from or close to each other along a length direction of the base. The communication chip is disposed on the base, is coupled to the antennas, and is configured to process the wireless signal.

### CROSS-REFERENCE TO RELATED APPLICATIONS

This Non-provisional application claims priority under 35 U.S.C. § 119(a) on Patent Application No(s). TW108200477 filed in Taiwan, Republic of China on 2019 Jan. 10, the entire contents of which are hereby incorporated by reference.

### BACKGROUND

### Technology Field

The present invention relates to a docking station.

### Description of the Related Art

A computer has been evolved from a desktop computer to a small and portable laptop computer, and has been going towards strong computing power, a fast speed, a more delicate screen image, and power saving. At present, in a home, a personal studio, or a company, electronic devices such as desktop computers and laptops are mainly used for Internet access, multimedia, audio-visual entertainment, and document edition.

The current electronic devices are designed to be small in size, light in weight, and easy to carry, etc. Due to the limited sizes of the mechanical components the electronic devices might be equipped with an external docking station to connect other electronic devices, thereby meeting expansion demands.

However, the docking station usually has a fixed size corresponding to the electronic devices. A user must consider the compatibility when buying a new electronic device. Otherwise, the docking station cannot be used for the new electronic device.

### SUMMARY

The present invention provides a docking station that can adapt to electronic devices in various sizes.

The docking station of the present invention includes a base, a pair of support frames, two pairs of antennas, a pair of first connecting ports, and a communication chip. The support frames, the connecting ports, and the communication chip are all disposed on the base. The support frames rotate relative to the base, the antennas are disposed in the support frames to receive a wireless signal, and the first connecting ports are movably disposed on the two opposite sides of the base, and the first connecting ports are capable of moving far away from or close to each other along a length direction of the base. The communication chip is disposed on the base, coupled to the antennas, and configured to process the wireless signal.

In an embodiment of the present invention, each of the foregoing two pairs of antennas includes two dual-band antennas.

In an embodiment of the present invention, the foregoing support frames are I-shaped, and a pair of LEDs is disposed at ends of the respective support frames that are far away from the base.

In an embodiment of the present invention, the foregoing support frames are L-shaped, and an LED strip is connected between the ends of the L-shaped support frames.

In an embodiment of the present invention, the foregoing pair of first connecting ports is a pair of Type-C connectors.

In an embodiment of the present invention, the foregoing communication chip is in an AX mode or an AD mode.

In an embodiment of the present invention, a foot stand pivoted at a bottom of the base is further included, and the foot stand rotates outwards relative to the base. In addition, a non-slip pad is further included, and the non-slip pad is disposed at an end of the foot stand that is far away from the base.

In an embodiment of the present invention, a plurality of second connecting ports disposed on the base are further included, where the second connecting ports include USB 3.0, RJ45, Type-C, HDMI, and Micro SD.

In an embodiment of the present invention, the base further includes a plurality of heat-dissipating holes.

Based on the foregoing, the first connecting ports of the docking station of the present invention are designed to move relative to the base, so that the docking station can be adapted to the electronic devices of different sizes.

In order to make the aforementioned and other objectives and advantages of the present invention comprehensible, embodiments accompanied with figures are described in detail below.

### BRIEF DESCRIPTION OF THE DRAWINGS

FIG. 1 is a schematic diagram of a docking station according to an embodiment of the present invention.

FIG. 2 is a schematic diagram of an electronic device correspondingly docked in the docking station of FIG. 1.

FIG. 3 is a schematic diagram of a docking station according to another embodiment of the present invention.

FIG. 4 is a schematic diagram of an electronic device correspondingly docked in a docking station of FIG. 3.

### DETAILED DESCRIPTION

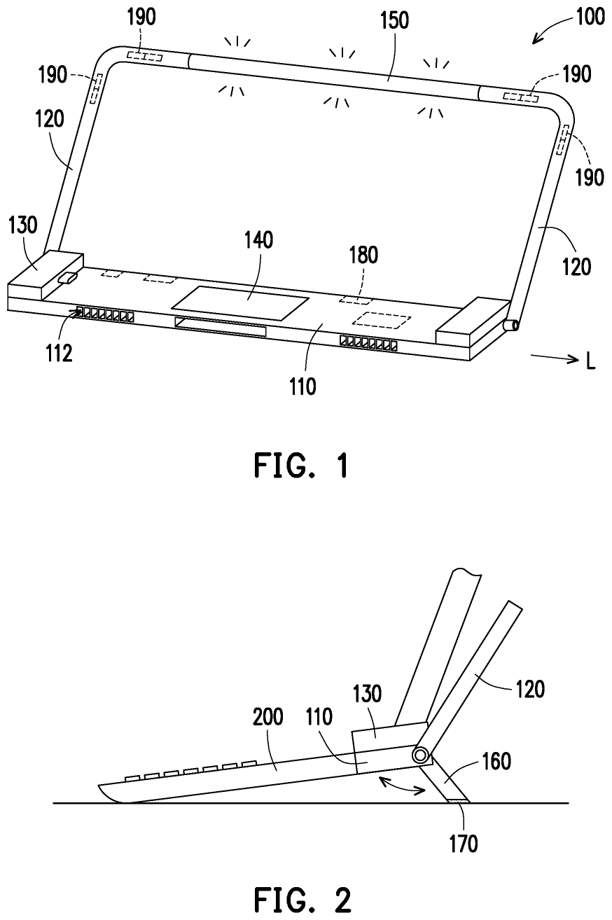

FIG. 1 is a schematic diagram of a docking station according to an embodiment of the present invention. Referring to FIG. 1, a docking station 100 of this embodiment includes a base 110, a pair of support frames 120, two pairs of antennas 190, a pair of first connecting ports 130, and a communication chip 140. The base 110 may be made of aluminum magnesium alloy, and, therefore, is light and thin. The support frames 120, the connecting ports and the communication chip are all disposed on the base 110. The support frames 120 are pivoted on two opposite sides of the base 110 so the support frames 120 is capable of rotating relative to the base 110, and the antennas 190 are disposed in the support frames 120 to receive a wireless signal. The first connecting ports 130 are movably disposed on the two opposite sides of the base 110, and the first connecting ports 130 and the support frames 120 are disposed at the same side. The first connecting ports 130 face each other and can move far away from or close to each other along a length direction L of the base 110. The communication chip 140 is disposed on the base 110 and coupled to the antenna 190 to process the wireless signal. The communication chip 140 is, for example, in an AX mode or an AD mode, but is not limited thereto.

Specifically, the first connecting ports 130 may be Type-C connectors. A sliding groove (not shown) may be disposed on either the base 110 or the first connecting ports 130, and a bump (not shown) is disposed on the other one (the base 110 or the first connecting ports 130). The bump is correspondingly embedded into the sliding groove so the first connecting ports 130 can slide relative to the base 110 along the length direction L of the base 110.

Certainly, a manner by which the first connecting ports 130 move far away from or close to each other along the length direction L of the base 110 is not limited to the foregoing. Those skilled in the art can change a corresponding structure as required without violating the spirit and achieve the same objective.

As mentioned above, each pair of antennas 190 includes two dual-band antennas. In this way, a 4×4 multi-input multi-output (MIMO) antenna communication system may be implemented. Certainly, the number of dual-band antennas may be changed according to practical demands, or may be a set of 8×8.

The foregoing support frames 120 may be L-shaped, and the ends thereof face each other. The docking station 100 may further include an LED strip 150, which is connected between the ends of the two L-shaped support frames 120 to provide lights when the antennas 190 performs communication so a user is aware that the antennas 190 are performing communication.

The docking station 100 further includes a foot stand 160 pivoted at the bottom of the base 110. The foot stand 160 can rotate outwards relative to the base 110. In addition, the docking station 100 further includes a non-slip pad 170 disposed at an end of the foot stand 160, which is far away from the base 110.

FIG. 2 is a schematic diagram of an electronic device correspondingly docked in the docking station of FIG. 1. Referring to FIG. 2, when the docking station 100 is in use, a user first separates two first connecting ports 130 far away from each other, so the distance between the first connecting ports 130 is greater than the width of an electronic device 200 (for example, a laptop). Next, the electronic device 200 is placed on the base 110, and the first connecting ports 130 are slid closer to each other and plugged into connecting ports (not shown) of the electronic device 200 corresponding to the first connecting ports 130.

When first connecting ports 130 are plugged into the corresponding connecting ports of the electronic device 200, the electronic device 200 can be fixed on the docking station 100, and the electronic device 200 may be electrically connected to the docking base 100.

In addition, the first connecting ports 130 may be capable of moving closes to or far away from each other along a length direction L of the base 110, that is, the distance between the two first connecting ports 130 may be adjusted. Therefore, the docking station 100 may be adapted for electronic devices 200 of different sizes.

In addition, a function of antennas of the electronic device 200 may be enabled through software of the electronic device 200, and the electronic device 200 performs communication through the antennas 190 of the docking station 100.

In particular, because antennas disposed in the electronic device 200 are only 2×2 there may be a problem for expansion of communication function. After the electronic device 200 is assembled with the docking station 100 of the present invention, the antennas 190 of the docking station 100 may provide the electronic device 200 with faster and more reliable signal transmission quality than the antennas disposed in the electronic device 200 do because the antennas 190 of the docking station 100 are 4×4.

Moreover, the transmission power of the antennas 190 of the dock station 100 may be adjusted through the software of the electronic device 200 for power saving.

Furthermore, the support frames 120 may rotate relative to the base 110 so the user may adjust angles of the antennas 190 relative to the base 110, to improve a communication efficiency of the antennas 190. When the antennas 190 perform communication, an LED strip 150 provides lights. The lights emitting from the LED strip 150 may be adjusted and set by the software of the electronic device 200, and the software can change luminance and colors of the lights depending on different operation modes or scenarios.

Referring to FIG. 1 and FIG. 2 together, the docking station 100 further includes a plurality of second connecting ports 180 disposed on the base 110. The second connecting ports 180 include USB 3.0, RJ45, Type-C, HDMI, and Micro SD, etc. The installment of the second connecting ports 180 allows the electronic device 200 to connect with other electronic devices, for example, a display screen and a loudspeaker, etc. in a wired manner.

It should be noted that for user friendly, a foot stand 160 of the docking station 100 may be further rotated outwards to stand on a desktop, further increasing an operation angle of the electronic device 200. In this way, the user can type on a keyboard of the electronic device 200 at a more ergonomic angle. A non-slip pad 170 disposed at an end of the foot stand 160 far away from the base 110 helps the foot stand 160 to stay firmly on the surface of a desk, preventing the foot stand 160 from moving.

In addition, the electronic device 200 generates a lot of heat during the operation. The base 110 made of aluminum magnesium alloy is in contact with the bottom of the electronic device 200 so the electronic device 200 can dissipate the initial heat through the base 110 in a conductive manner, and the foot stand 160 rotates outwards relative to the base 110 to elevate the base 110, further improving the heat dissipating effect. Furthermore, a plurality of heat-dissipating holes 112 may be further disposed on the base 110, and these heat-dissipating holes 112 enhances the heat dissipation to further improve the heat dissipating effect.

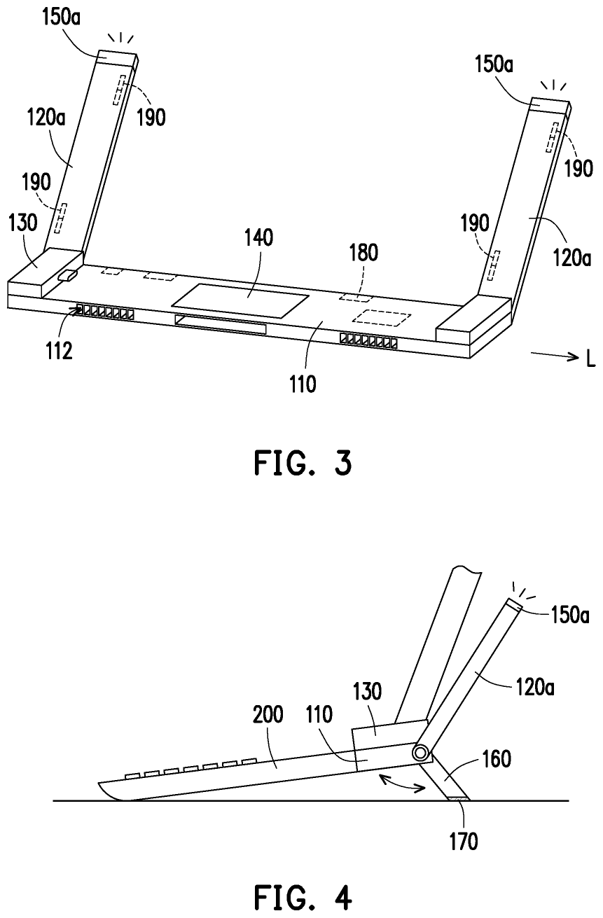

FIG. 3 is a schematic diagram of a docking station according to another embodiment of the present invention, and FIG. 4 is a schematic diagram of the electronic device correspondingly docked in the docking station of FIG. 3. Referring to FIG. 3 and FIG. 4, the difference between this embodiment and the foregoing embodiment lies in that: a pair of support frames 120a of this embodiment is I shaped instead of L-shaped, and there is no LED strip 150 connected between the pair of support frames 120a, but LEDs 150a are disposed at the far ends (not marked) of the respective support frames 120a relative to the base 110.

In comparison to the foregoing embodiment, angles of the antennas 190, relative to a base 110, may be adjusted individually according to user demands to achieve a better signal transmission effect because the support frames 120a of this embodiment are not connected together by the LED strip 150.

Similarly, the LEDs 150a at the ends of the support frames 120 may be adjusted and set through the software of the electronic device 200.

In summary, the first connecting ports of the docking station of the present invention is designed to move relative to the base so that the docking station can be adapted to the electronic devices of different sizes.

Moreover, the docking station is equipped with a plurality of second connecting ports and also in such a light and simple shape. Therefore, the docking station can not only keep its expansion function, but also be user friendly to the user.

In addition, compared to the antennas of the electronic device, the antennas of the docking station can provide the electronic device with faster and more reliable network transmission quality.

Although the present invention has been disclosed above through the embodiments, the embodiments are not intended to limit the present invention. Any person of ordinary skill in the art can make some variations or modifications without departing from the spirit and scope of the present invention. Therefore, the protection scope of the present invention shall be subject to the appended claims.

What is claimed is:

1. A docking station, comprising:
a base;
a pair of support frames pivoted on two opposite sides of the base, the pair of support frames rotating relative to the base;
two pairs of antennas disposed on the respective support frames, the two pairs of antennas being configured to receive a wireless signal;
a pair of first connecting ports movably disposed on the two opposite sides of the base and being capable of moving away from or close to each other along a length direction of the base; and
a communication chip disposed on the base and coupled to the two pairs of antennas, the communication chip being configured to process the wireless signal.

2. The docking station according to claim 1, wherein each of the two pairs of antennas comprises two dual-band antennas.

3. The docking station according to claim 1, wherein the support frames are I-shaped.

4. The docking station according to claim 3, further comprising a pair of LEDs disposed at ends of the respective support frames that are far away from the base.

5. The docking station according to claim 1, wherein the support frames are L-shaped.

6. The docking station according to claim 5, further comprising an LED strip connected between the ends of the pair of L-shaped support frames.

7. The docking station according to claim 1, wherein the pair of first connecting ports is a pair of Type-C connector.

8. The docking station according to claim 1, wherein the communication chip is in an AX mode or an AD mode.

9. The docking station according to claim 1, further comprising a foot stand pivoted at a bottom of the base and rotating outwards relative to the base.

10. The docking station according to claim 9, further comprising a non-slip pad disposed at an end of the foot stand that is far away from the base.

11. The docking station according to claim 1, further comprising a plurality of second connecting ports disposed on the base.

12. The docking station according to claim 11, wherein the second connecting ports comprise USB 3.0, RJ45, Type-C, HDMI, and Micro SD.

13. The docking station according to claim 1, wherein the base further comprises a plurality of heat-dissipating holes.
